(19) United States
(12) Patent Application Publication
(10) Pub. No.: US 2005/0282134 A1
(43) Pub. Date: Dec. 22, 2005

(54) System and method for training sales personnel in new business prospecting

(76) Inventor: Gary W. Hoy, Tonawanda, NY (US)

Correspondence Address: HODGSON RUSS LLP, ONE M & T PLAZA, SUITE 2000, BUFFALO, NY, 14203-2391, US

(21) Appl. No.: 11/055,134

(22) Filed: Feb. 10, 2005

Related U.S. Application Data
(60) Provisional application No. 60/543,346, filed on Feb. 10, 2004.

(51) Int. Cl. G09B 5/00; G09B 7/00

(52) U.S. Cl. 434/323

(57) ABSTRACT

A computer-based training system and method for use by sales personnel. Training materials on CDs are supplied to the participants who after reviewing the materials and participating in training exercises record information and data pertaining to results of the process. The information and data are input to computer software which processes the same to produce reports and charts organized on both an individual and group basis.

### CROSS REFERENCE TO A RELATED APPLICATION

Applicant claims priority based on provisional application No. 60/543,346 filed Feb. 10, 2004 and entitled “System And Method For Training Sales Personnel In New Business Prospecting”, which is incorporated herein by reference.

### BACKGROUND OF THE INVENTION

This invention relates to the art of business methods, and more particularly to a new and improved computer software-based training system and method.

### SUMMARY OF THE INVENTION

Training materials on CDs are supplied to the participants who after reviewing the materials and participating in training exercises record information and data pertaining to results of the process. The information and data are input to computer software which processes the same to produce reports and charts organized on both an individual and group basis.

### BRIEF DESCRIPTION OF THE DRAWING

FIG. 1 is a block diagram illustrating the system and method of the invention.

### DETAILED DESCRIPTION OF THE INVENTION

Contacting 101—A 50 minute course taught on one CD.

Call reluctance program. There are five steps described in the course to rid sales people of call reluctance (also referred to as “how to develop call courage”). They are as follows:
1. Recognize you have it.
2. Locate and isolate the fear.
3. Where does the fear come from?
4. Lack of an agenda creates doubt.
5. Get rid of it. This is explained through the use of an analogy (hockey goalie being afraid of the puck).

How to identify and increase what motivates people to perform. The key point being the “Gameboy Principle” which helps identify the true basis of motivation.

The role environment has in becoming successful. This is done through the use of a comparison of N. Korea and S. Korea. Also, from what is described as “The Environmental Garden Hose.” There is an exercise which details whether time and money is being used as a resource, or wasted. Referred to as “Participant vs. Spectator.”

The Contacting 101 process is as follows:
1. Listen to a tape or CD each day. Also, read 15-20 minutes each day.
2. Make 5 voice to voice contacts each day.
3. Check-in with an accountability partner/mentor.
4. Place a check in the center of the box.

Exercise to determine commitment is done through the use of, “Pick up the Pen.”

A beginning dialogue. The Appointment University dialogue is established through 8 components with a comparison to building a pair of shoes. The components are as follows:
1. Persepctive on what you do and sell.
2. Summary statement—established through an exercise of listing company product/service features.
3. Benefit statement—established through an exercise of listing company benefits from their product/service. This is assisted with what is referred to as the “$64,000 question.” (“You just met with a potential client; they're on their way home-why do they feel better?”).
4. Pre-emptive listening. Communicated through the use of “The Bird in the Garage” story. Establishing prospects—do not listen to your message until you listen to their questions. These questions are covered by the “Five Flags” of prospecting—the flags are; Who are you? Where do I know you from? Where did you get my name? Why are you calling me? What are you selling?
5. “Favor and Feedback.” Used to create a friendly and non-confrontational attitude to the sales call.
6. Respect the potential client's time.
7. Your personality. Only becomes a factor after tension (reluctance) has been eliminated.
8. Have an answer to the question, “What is it you're doing?” and “Can you tell me a little more about what you do?” This is done by having a back-up summary or benefit statement ready.

Conclusion is “Why does this work?” Explained thorugh the following cycle: dream/purpose, activity, feedback, learning, effectiveness, confidence . . . this leads to the cycle starting over, only stronger.

Program has 1 chart and 1 worksheet (enclosed).

Width 201—A 28 minute course taught on 1 CD.

The power of constantly having new clients in your schedule. Industry data is used to show the more time spent prospecting and meeting new potential clients, the greater the exponential growth in income. Therefore, the point system recognizes this by rewarding a greater point total based on the number of meetings in a given month.

A key to becoming effective on the phone is understanding the difference between content (what to do) and context (how to look at what you do). There is a discussion relating to the way the dominant characteristic of a phone call starts out as process and turns into attitude. This is confirmed through the use of a joke about “Ground Beef.”

How fear controls your perspective and limits your motivation. This is done by detailing the presence of fear in everyone; however, the size of the dream/purpose becomes the variable which determines success.

Fail your way to success. Compares the perspective of people in the top 5% income bracket with those in the remaining 95%. This is related to the way they look at “failure.”

Relates prospecting to a deck of cards. You need to “fill the funnel in order to find the aces.” This allows you to find the percentage of people you can sell to, rather than change the percentage.

The Width 201 process.
1. Five calls each day along with listening to a tape/CD and reading 15-20 minutes in a book (6 points).
2. List the people you set up meetings with (2 points).
3. List the people who say “no” to you (2 points).
4. List the referrals you receive, with names and numbers (2 points).
5. List the people you've created actual written business with (5 points).
6. Review your goals (Thursday) and prepare your list of names to call (Friday)—this is scored as part of the requirements from step 1 above (6 points).
7. Place total at the bottom of chart provided.
8. Meeting chart—place all actual face-to-face meetings in their appropriate spot on sheet. Chart stresses the importance of the constant flow of new prospects through a point system which weighs each successive meeting heavier than the previous. For example, the first meeting of the month is worth 1 point; the second is worth 2 . . . etc. The 20^{th} meeting is worth 50.
9. Dream/purpose Report. Participants receive 30 points for going out and experiencing something, like test driving a car or walking through a home they might like to own someday.
10. Master chart tabulates all the points for the month. Company can adjust desired point totals, but basic goal is to attain 500. At the end of the 4 week period, however, there is a tangible number produced which can be used to assess the participant and also prescribe learning content.

Hurdles to 500 points are detailed through an exercise. The participant is asked to list all their perceived obstacles to reaching the required 500 points. Then asked if they are hurdles or excuses if the reward for 500 points was $50,000.

The Pyramid of Success. Each area of the program builds a foundation. The areas are as follows; internal environment, external environment (books and tapes/CD's), positive activity, skill acquisition, effort and results. Income is a byproduct of who you become in the process of building the pyramid.

World's greatest fisherman. A story designed to explain “If the dream is big enough the facts don't count!”

Program has charts and 1 worksheet (enclosed).

Facilitator—A 14 minute disc taught on 1 CD.

Teaches managers how to implement the program. This is done not so much with mechanical process, rather with the proper attitude. Accomplished by reiterating the power of the Gameboy Principle from Contacting 101 and how important it is to establish and look for it in each participant.

There are three ingredients/perspectives the facilitator adds to the program:
1. Accountability
2. Performance, not results
3. Consistency, not volume

Cycle of Growth. Goes over in detail the cycle of activity discussed in Contacting 101 (“Why does this work?”).

Expectations as the facilitator come in two forms; high expectations for the program and positive expectations for the participant. The important differences are highlighted.

Information received back is outlined as an assessment tool for management. “That which gets measured accurately improves.”

Three types of feedback are taught to the facilitator:
1. The good—positive feedback.
2. The bad—negative feedback.
3. The ugly—no feedback.

Explained is the manner in which the width 201 system leverages a facilitator's time through the use of a “Content library” established at each office. This allows for a franchise like training system which allows companies to “send” people through training, rather than “walk” them through. The library will be established and upgraded with company input on a regular basis.

Conclusion stresses the importance of the system to do the work—just like a hand saw cuts wood.

Software/system—Will take data in and report bar graphs with monthly averages for each participant, and each office if desired. Data will reveal information which Appointment University will use to determine the next month's activity program, as well as the books and tapes/CD's the participant should use from the content library. This will be called an “Activity Profile.”

The goal of Appointment University is to provide a comprehensive system for training and evaluating either existing agents, or the suitability of hiring potential agents due to the activity assessment. We provide not just the content of the university, but also the system to implement the concepts properly and efficiently.

All aspects of the University will have additional components such as personalized coaching sessions and on site seminars. These will come as needed and at an additional fee to the company.

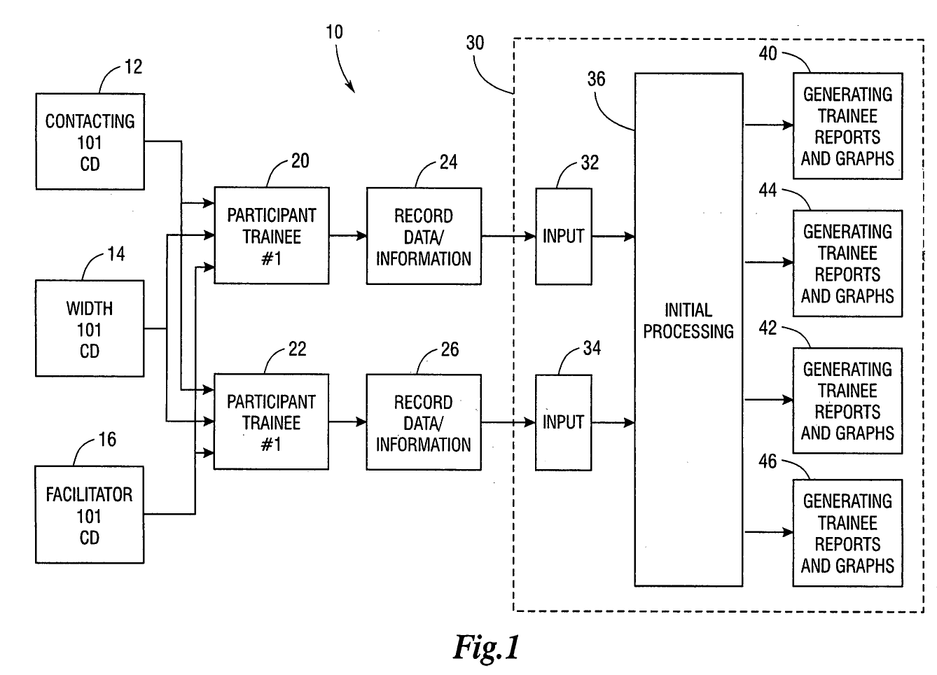

The system 10 and method of the invention is illustrated further in FIG. 1. The Contacting 101, Width 101 and Facilitator 101 CDs are designated 12, 14 and 16, respectively. They are used by a plurality, N, of participants or trainees, two of which are designated 20 and 22 in FIG. 1. After listening to CDs and participating in various exercises and activities the participants record data and information. This function is designated 24 for participant 20 and 26 for participant 22. The recorded data and information is input to the software, generally designated 30 which includes corresponding components 32 and 34 for receiving the data and information. The software 30 includes a component 36 for initially processing the received data and information. In addition, the software includes a plurality of components, two of which are designated 40 and 42 for generating reports and graphs corresponding to individual participants/trainees, and two of which are designated 44 and 46 for generating reports and graphs corresponding to groups of participants/trainees, such as those for an entire office.

The system and method of the invention is described further in the attached Appendices A, B, C and D. Appendix A further describes the Contacting 101 process previously described on page 2, Appendix B further describes the Width 201 process previously described on page 3, Appendix C further describes the Faciliator process previously described on page 4 and Appendix D contains an illustrative report generated by the system.

1. A computer-based training system comprising:
a) a training materials storage section for providing training program information and exercises for access by a trainee using the system;
b) a data and information recording section for receiving data and information from a trainee after accessing and utilizing the training program information and exercises of the training materials storage section; and
c) a computer operatively connected to the data and information recording system and containing software including a component for processing data and information received from the data and information recording section and at least one additional component for generating reports and graphs containing information on the trainee's performance in relation to the training program information and exercises.

2. The system of claim 1, wherein the training materials storage section includes a plurality of compact disc components each containing a different training program and related exercises.

3. The system of claim 1, wherein the software includes a component for generating reports and graphs on the performance of an individual trainee and a component for generating reports and graphs on the performance of groups of trainees.

4. A computer-based training method comprising:
a) storing training program information and exercises for access by a trainee;
b) receiving data and information from a trainee after accessing and utilizing the training program information and exercises;
c) processing data and information received from the trainee in a computer; and
d) utilizing the computer to generate reports and graphs containing the trainee's performance in relation to the training program and exercises.

5. The method of claim 4, wherein storing training program information and exercises comprises providing a plurality of compact discs, each containing a different training program and related exercises.

6. The method of claim 4, wherein the computer is utilized to generate reports and graphs on the performance of an individual trainee and to generate reports and graphs on the performance of groups of trainees.
